(19) United States
(12) Patent Application Publication
(10) Pub. No.: US 2010/0169803 A1
(43) Pub. Date: Jul. 1, 2010

(54) Method and System for Implementing User Generated Preferences in a Communication System

(76) Inventors: Elizabeth Mazzei, San Francisco, CA (US); Deept Kumar, San Francisco, CA (US); Jasminder Banga, San Francisco, CA (US); Nitin J. Shah, Cupertino, CA (US)

Correspondence Address: COURTNEY STANIFORD & GREGORY LLP, 10001 N. De Anza Blvd., Suite 300, Cupertino, CA, 95014, US

(21) Appl. No.: 12/632,766

(22) Filed: Dec. 7, 2009

Related U.S. Application Data
(60) Provisional application No. 61/120,333, filed on Dec. 5, 2008.

(51) Int. Cl. G06F 3/048

(52) U.S. Cl. 715/760; 715/764

(57) ABSTRACT

Embodiments of a distributed network system that implements a user-generated preferences (UGP) method to obtain meaningful data regarding user choices and profile data are described. The UGP process is implemented as an interactive application used to understand and segment internet users through graphical question and answer methodology. Over time as internet users participate and interact with the application more preferences are discovered which creates a silo, or profile, of information unique to each user. The interactive question and answer structure is directed to consumer users who are accessing specific websites or browsing the Internet. The UGP process provides the ability for a content provider to engage the user at several different times during the web browsing session, each in a slightly different way, but each in an equivalently engaging way.

### CROSS-REFERENCE TO RELATED APPLICATIONS

The present application claims the benefit of the U.S. Provisional Application No. 61/120,333 entitled “Method and System for Implementing User Generated Preferences in a Communication System,” and filed on Dec. 5, 2008.

### FIELD

Embodiments of the present invention relate generally to computer network systems, and more specifically to delivery of online content based on user preferences.

### BACKGROUND

Communication over the Internet largely involves the serving of directed or targeted content from content providers to users. Such targeted content typically comprises advertisements or supplemental messages that are linked or associated with content that is sent to the user in response to a direct request. For example, many Internet Service Providers (ISPs) work in conjunction with advertisers and other targeted message providers to serve directed ads to users during the normal course of a user's web browsing session.

Ad serving represents a very significant industry and represents the bulk of funding available to content providers, and social networking websites. Effective ad serving requires that the ad messages be relevant to the user. This requires some degree of information to be known about individual users. Various solutions have been developed to gather user information, compile user profiles and develop targeted ad campaigns to help advertisers and content providers more effectively target specific audiences. Such solutions may involve the use of covert mechanisms that may be perceived as involving some degree of privacy violation through tracking of online traffic behavior, such as the use of cookies, which are data objects that are placed directly on the user's computer itself, often without the user's knowledge or consent. Other mechanisms include deep packet inspection (DPI), which is a form of computer network packet filtering that examines the data and/or header part of a packet as it passes a network inspection point. These techniques have increasingly implicated privacy and personal security concerns, as such methods and information can be potentially harmful to users if they are abused.

Other means for obtaining user information for purposes of supporting directed media include the use of questionnaires to obtain user data. Such methods are considered burdensome and often annoying to users, and are thus often ignored or filled in only superficially by users. This results in limited utility of such an approach.

What is needed, therefore, is a user profile generation system that obtains meaningful information from users without being overly obtrusive.

What is further needed is a user profile generation system that obtains demographic information from users without comprising user privacy or utilizing personally identifiable information.

### BRIEF DESCRIPTION OF THE DRAWINGS

Embodiments are illustrated by way of example and not limitation in the figures of the accompanying drawings, in which like references indicate similar elements, and in which:

FIG. 1A illustrates a sample layout for the questions and graphical response used in the User-Generated Preferences (UGP) application, under an embodiment.

FIG. 1B illustrates an example question and graphical response for use in a UGP application.

FIG. 2 is an example of the tabular representation used for class assignments, under an embodiment.

FIG. 3 is an example of a decision tree constructed using a simulated data set, under an embodiment.

FIG. 4 illustrates the session and device characteristics that can be discovered by the UGP application, under an embodiment.

FIG. 5 is a table that illustrates the user preferences that can be discovered by the UGP application, under an embodiment.

FIG. 6 is a sample layout for the questions and graphical responses used in the application on a mobile device, under an embodiment.

FIG. 7 illustrates a high level architectural view of a network traffic tagging system, under an embodiment.

FIG. 8 illustrates a client-server network including a network tagging component, according to an embodiment.

FIG. 9 is a flowchart that illustrates a method of generating a request ID (RID), under an embodiment.

FIG. 10 is a flowchart that illustrates a method of tagging network traffic with relevant user and/or network client information, under an embodiment.

FIG. 11 illustrates an example HTTP header including a network traffic tag, according to an embodiment.

FIG. 12 illustrates the composition of the RID tag, under an embodiment.

### INCORPORATION BY REFERENCE

Each publication and/or patent mentioned in this specification is herein incorporated by reference in its entirety to the same extent as if each individual publication or patent was specifically and individually indicated to be incorporated by reference.

### DETAILED DESCRIPTION

Embodiments are directed to a network interface system that provides the basis for obtaining useful user preference and profile information while addressing certain key concerns regarding maximizing consumer experience and maintaining user privacy.

As the global online advertising marketplace grows exponentially over the next several years, the Internet advertising community is looking for more effective ways to optimize their ROI (return on investment). Traditional methods of obtaining user information for purposes of creating targeted messages to Internet users are reaching their limits in terms of providing an effective targeting tool. Reliance on traditional questionnaires to obtain profile information about users is reaching a limit as the amount of interaction required by users becomes onerous. Automated solutions, such as cookies and inspection-based mechanisms that track actual user behavior are becoming increasingly disfavored as they are seen to negatively implicate privacy and security concerns.

Embodiments are directed to an information system that facilitates targeted message delivery through mechanisms that overcome certain shortcomings of present methods. A graphical user interaction utilizing simple question and answer panels is provided as part of the login sequence of a web session. The questions are generally simple and neutral, and a simple mouse click or single selection is all that is required for the user to answer a question. The questions and answers implicate no aspects of user privacy or personal information, but they still provide a means to build a meaningful profile of user preferences that can be utilized during the browsing session or by a targeted content provider.

The present description makes reference to users or clients in a distributed computer network system. The term “user” refers generally to a person that uses a computer, network client, or any computing device to access other computers or servers over a computer network, such as the Internet. It should be noted that the term “user” may also refer to the device itself. The terms “user,” “client,” “consumer,” “customer,” or “subscriber” may be used interchangeably to refer to any entity that accesses resources on the network. In the present description, the term “user” may include both singular or plural entities. Thus, a user may represent a single entity, such as a single person or device, or it may represent a community or network of users or devices, which share one or more common characteristics, such as location, demographics, profiles, interests, and so on.

### User-Generated Preferences

In one embodiment, a distributed network system implements a user-generated preferences (UGP) method, also known as single-click impressions (SCI), to obtain meaningful data regarding user choices and profile data. The UGP process is implemented as an interactive application used to understand and segment internet users through graphical question and answer methodology. Over time as Internet users participate and interact with the application more preferences for these users are discovered. This collection of data creates a silo, or profile, of information unique to each user. The interactive question and answer structure is directed to consumer users who are accessing specific websites or browsing the Internet with a particular purpose. The UGP process provides the ability for a content provider to engage the user at several different times during the web browsing session, each in a slightly different way, but each in an equivalently engaging way.

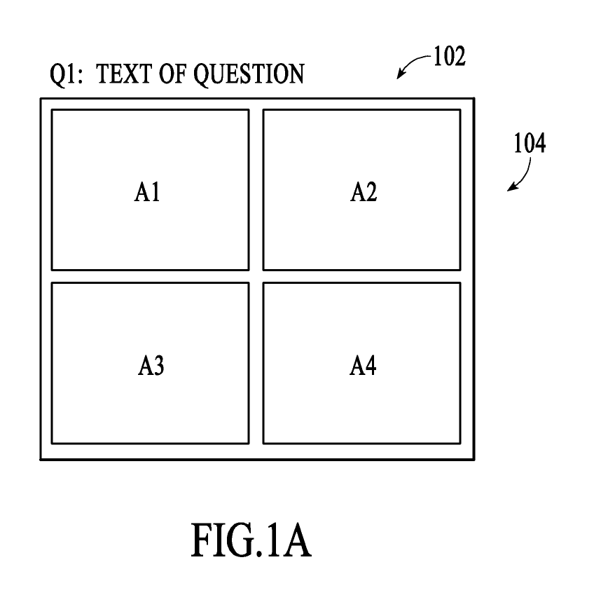

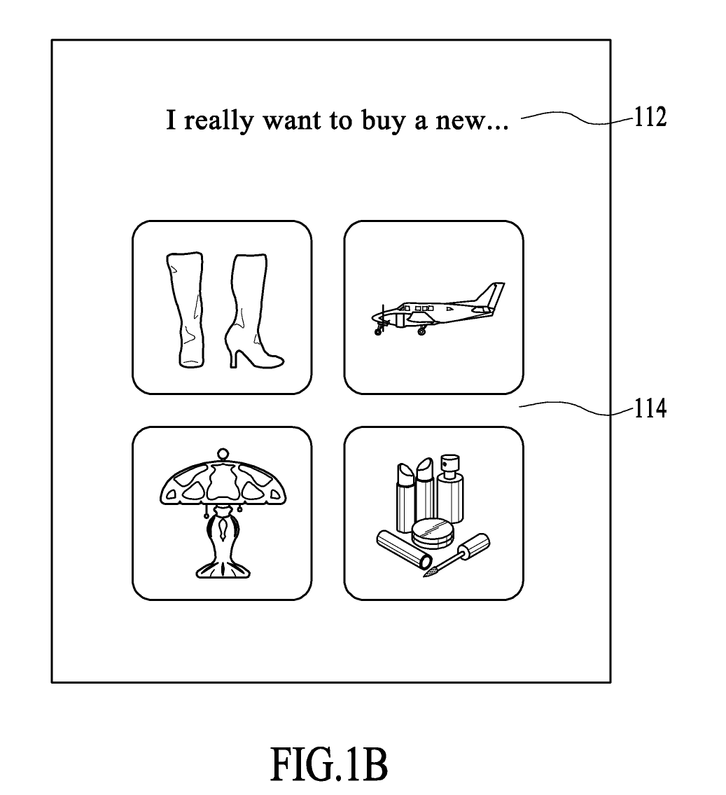

In one embodiment, a UGP process module generates a question with graphical picture answers for display to the user. The user reads the question, chooses to participate and selects the appropriate and corresponding picture that identifies a preference or characteristic unique and relatable to that particular user. FIG. 1A illustrates a sample layout for the questions and graphical response used in the User-Generated Preferences application, under an embodiment. As shown in FIG. 1, the text of a question 102 is displayed proximate a number (e.g., two, three, or four) potential picture answers 104. The picture answers are images of objects, places, people, etc. that are relevant to a particular aspect of the question. The selected picture represents the answer to the question and provides some insight as to the user's preference or background regarding subject matter of the question. FIG. 1B illustrates an example question and graphical response for use in a UGP application. As shown in FIG. 1B, the question 112 states that the user “wants to buy a new . . . ” something, and the response panels 114 are displays of four pictures related to different objects. In general, the answers reveal a simple objective fact about the user. In this case of FIG. 1B, the illustrated objects may provide an idea the user's gender. That is, selecting makeup may indicate the user is a women, whereas selecting the model airplane may indicate the user is a man.

A series of different question and answer display screens may be provided during a user's interaction on a website or series of websites. The first question may be related to a specific aspect of the website, such as the type of product or service provided by the website. Successive questions may then be directed to relevant aspects of the user's navigation through the website, or on input in the website, or even on answers to previous questions. Thus, for example, the question/response of FIG. 1B may be provided as the first question in a general merchandise site, and the user response may provide access to specific departments within the site. Alternatively, FIG. 1B may be displayed in any site, in which the information regarding the gender of the user is helpful. In this case, providing the graphical question/answer window provides a more interesting or fun way for the user to provide this information, as opposed to the system asking explicitly “are you male or female?”

The picture answer selected by each user is stored in a virtual silo, or bucket, as a preference of the user that answered under an anonymous device ID. Over time as the user takes advantage of the application and chooses to interact, the question and answer process is repeated by using different questions and answers to capture more unique preferences and characteristics about that user, thereby enriching the silo of information. As the silo fills up with preferences selected by the user, the information known by the network becomes invaluable.

In one embodiment, the anonymous device ID associated with the user comprises the MAC (media access controller) ID number for a MAC device used by the user to access the Internet. The MAC address may be encoded, encrypted, or otherwise manipulated to generate a unique ID that specifically identifies the user through his or her client computer. The answer to the one or more questions is provided by the graphical user interface in a simple format indicating the question number and selected answer, such as 1A, 2D, 3B, etc. This indicates that the answer to question 1 was picture A, the answer to question 2 was picture D, the answer to question 3 was picture B, and so on. This answer data is stored in a database entry that is referenced by the unique identifier for the user. The answer data can then be used to build demographic information related to the user through a process that decodes the answer data to specific profile characteristics. For example, answer 1A may correspond to gender=man, answer 2D may correspond to age group=30-35, and so on. As a user answers more questions during the course of one or more web browsing sessions, the demographic data for the user is grown, and as the questions relate to buying preferences, the silo for the user fills up with profile and preference information. In one embodiment, this data is then packaged for delivery and use by content providers that may be interested in sending targeted ads or other content to the user. Different types of format for the demographic data may be employed depending on the constraints and requirements of the system and content providers.

To safeguard and ensure user privacy, the user preferences collected by the application does not contain any personally identifiable information (PII). As defined by the laws of the United States under the Online Privacy Protection Act, personally identifiable information is any piece of information which can potentially be used to uniquely identify, contact, or locate a single person. Examples of such are full name, telephone number, street address, e-mail and IP address. In an embodiment, the anonymous ID that is directly linked to the user and stores all the preferences selected is encrypted and protected by a one-way hash encryption scheme. The questions used in the application in no way ask or try to identify personal information, so user privacy is protected at all times.

The application is designed with a decision tree analysis system that processes and produces results in real time. The decision schema can decide based on the user's previous answer or answers, which question and picture answers should be served the next time the user interacts with the application. Based on the previous answer selected, the application automatically understands if the next question served will be either to confirm the previous selected preference or discover a completely new preference.

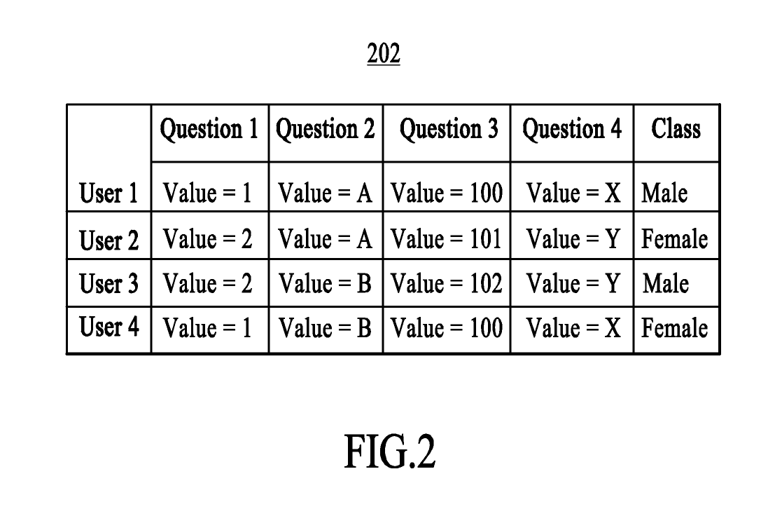

In one embodiment, the UGP application uses a tabular representation of control-set feature class assignments to provide input for the standard machine learning technique of decision tree construction. FIG. 2 is an example of the tabular representation used for class assignments, under an embodiment. Table 202 of FIG. 2 illustrates values attributed to each question of a series of questions provided to a number of users. The class distinction illustrated in table 202 is based on gender. Other classes include age (adult/child), location (east coast/west coast), and any other similar classes.

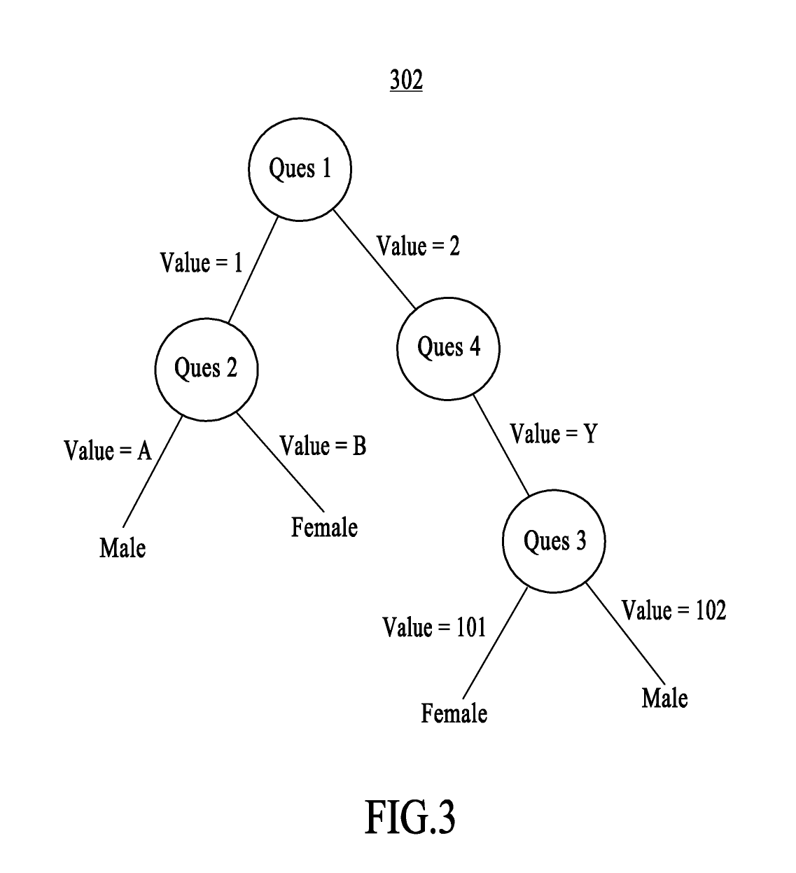

The mechanism used for constructing the decision tree can be chosen from any of the commonly used values, such as entropy, Gini index, or information gain, and so on. In the decision tree construct, the nodes correspond to questions and the leaves are assigned classes (demographic attributes) on the basis of the dominance or attributes. FIG. 3 is an example of a decision tree constructed using a simulated data set, under an embodiment. The real time decision of class assignment to users using the decision tree begins when a user is posed the first question, which corresponds to the top node “Ques 1” in decision tree 302. Depending on the answer chosen by the user at that time, a value is assigned to the answer selected and that value is set equal to 1 or 2. The next question that will be asked is determined based on the value of the answer selected the previous attempt, and stored locally for the next future attempt. For example, as shown in FIG. 3, if selected an answer with a value=1, the next question will be question 2. If selected an answer with a value=2, the next question will be question 4, and so on. The assignment of the class for each question answered is also stored and is used to determine a probabilistic class assignment to the user. As more questions are answered and the process is followed down the tree 302, the probability of class assigned to the user improves and in most cases reaches a value of 1 at the leaf node at which point the confidence level of class assignment has reached 100%.

The preferences or characteristics that can be discovered using the user-generated application can be categorized by session, by device and by user. The session and device characteristics are known by the network automatically. These characteristics include: the day, time and duration of each session, the type of client device (e.g., PC, Macintosh, PDA, PSP, etc.) that the user is using, the type of operating system (e.g., Microsoft, Linux, etc.), and the type of browser (e.g., Internet Explorer, Safari, Mozilla, etc.).

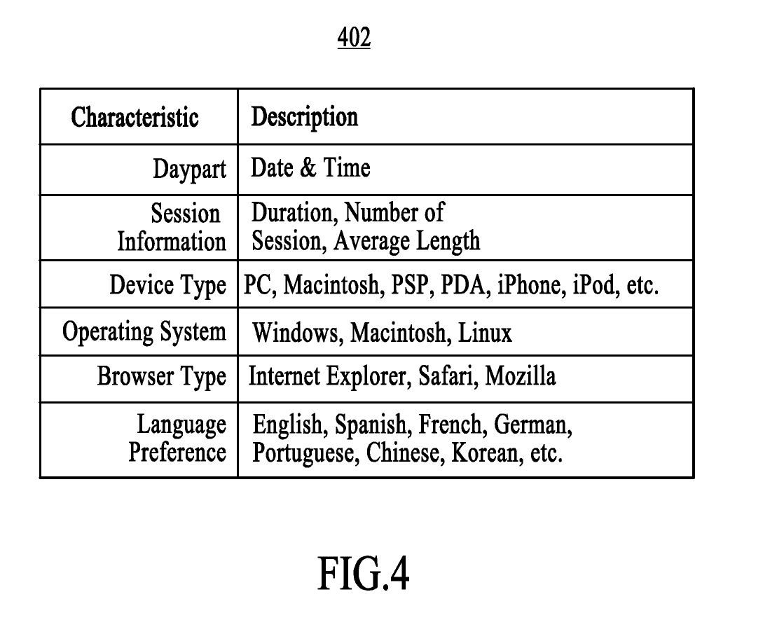

Additional information pertaining to the device, such as language preference, is chosen by the user at a predetermined time. This information is also visible to the network and can be compiled into the profile for each user. FIG. 4 illustrates a table 402 that lists the session and device characteristics that can be discovered by the UGP application, under an embodiment. It should be noted that the characteristics listed in table 402 are provided for example, and that many different or additional characteristics may also be in alternative embodiments.

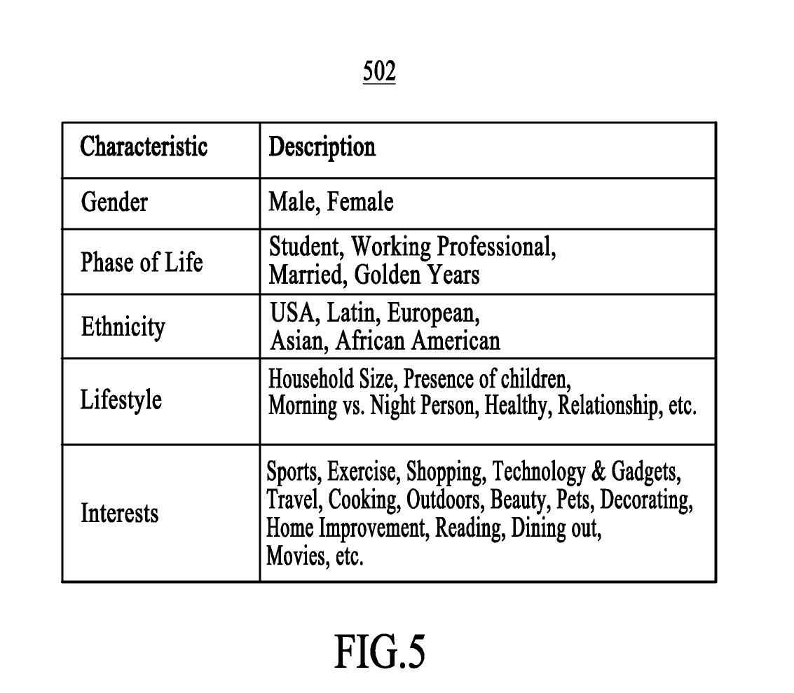

Many different aspects of user preference and profile may be obtained, depending on the application. In one embodiment, the user preferences and characteristics that the application attempts to discover are gender, phase of life, ethnicity, lifestyle and interests. FIG. 5 is a table 502 that illustrates the user preferences that can be discovered by the UGP application, under an embodiment. It should be noted that the preferences listed in table 502 are provided for example, and that many different or additional characteristics may also be in alternative embodiments.

There are several uses for the user-generated application that can provide benefits to a range of people and groups. The main use of the user-generated preferences application is to provide a means of better targeted and useful online content to the user, thereby optimizing and improving the online experience of the user across the Internet.

The unique IDs generated anonymously by the application can be integrated into advertisers' and publishers' technology to signal the viewing of certain websites by specific users who have interacted with the application. The content can then be altered to reflect the particular user's preferences making their experience on that website unique and specific to him/her, which increases the value of their online sessions. In addition, the IDs can be used by advertisers to serve unique advertisements to each individual. This not only increases the effectiveness of the advertisement and campaigns but also makes them relevant to the user; providing effective brand exposure and increasing the possibility of click-through, conversion and action.

The UGP application may be distributed as a stand-alone software program or component of a larger software program that can be distributed online and offline. Embodiments of the stand-alone software program include the ability to be packaged and distributed online and offline at physical locations, the ability to be used by users, publishers, advertisers, physical store owners, educational institutions and persons offline, and the ability to be “white labeled” as a software component of a larger software program, meaning sold and re-branded by purchasing third parties.

The UGP application can also be also implemented as a free-standing widget. In general, a widget is an element of a graphical user interface (GUI) that displays an information arrangement changeable by the user, such as a window or text box. The main function of a widget is to provide a single interaction point for the direct manipulation of a given kind of data. Widgets are basic visual building blocks which, combined in an application, hold all the data processed by the application and the available interactions on this data. As a widget, the UGP application can be used and adopted by online users, advertisers and publishers. The application as a widget provides the benefits of identifying user preferences and carries the anonymous user IDs along with it. Users can place the application as a widget on their social networking sites or personal homepages to simply share the fun and entertaining application or learn about the other users who are online and visiting their page who interact and ‘play’ with the widget. The UGP application has the ability to adapt, whereby the user can create questions and choose their own pictures to place as answers.

The decision scheme can be utilized as the user creates their own questions, by placing each original question in a category of preferences. The decision scheme can also be turned off and the user has the ability to create their own flow or method for the questions to be asked. The application as a widget can also be used by advertisers. Instead of random questions and graphical answers, the questions can be tailored to a specific client of the advertiser using products as choices. Advertisers can also take advantage of the widget by asking a more general question and having each different picture answer represent a different client, brand or product thereby exposing more than one client, brand or product at once. Other possibilities of the widget for advertisers include: brand exposure, games, and so on. Publishers can place the UGP application as a widget on their website to increase the level of user activity and enhance the online experience of their site. A publisher could tailor the questions specific to the content they serve to expose the visiting users to more information, learn more about their customers or simply add a way to keep users on their site for longer periods of time.

Features of the UGP application include, but are not limited to redirection, dissolution, polling and changing of answers. A feature of the application as a widget is the ability for the graphical answer chosen to either redirect or dissolve, revealing to the user a larger advertisement, a larger picture with more information pertaining to the answer chosen or a portal to display or request more information. Users, publishers and advertisers can all take advantage of this feature. An additional feature the UGP application as a widget is the ability to poll the answers selected and reveal to users how many other users chose the same answer and/or have similar silos of preferences. If the widget is employed on a social networking site, the polling can also relate the answers chosen to determine which of the users ‘friends’ or other users in their network selected the same answer or have similar silos of information. Likewise, the polling feature can be utilized by advertisers and publishers in much the same way.

The application can also carry a ‘change’ button feature through which if the graphical answers displayed meet none of the user's preferences or simply do not reflect the user's desired choice, the answer's can change by selecting the button. Other names for this button that can be used, but are not limited to, are ‘does not apply’ or ‘show more’. Lastly the widget can be utilized across many different sites or interests as a functional tool.

A genre of sites that could take advantage of the widget are do-it-yourself channels whereby the selected answers are steps taken in a process and the selection signals that the user wants more information. Other categories of sites that can take advantage of the application are shopping, auction, cooking, education, travel portals, etc.

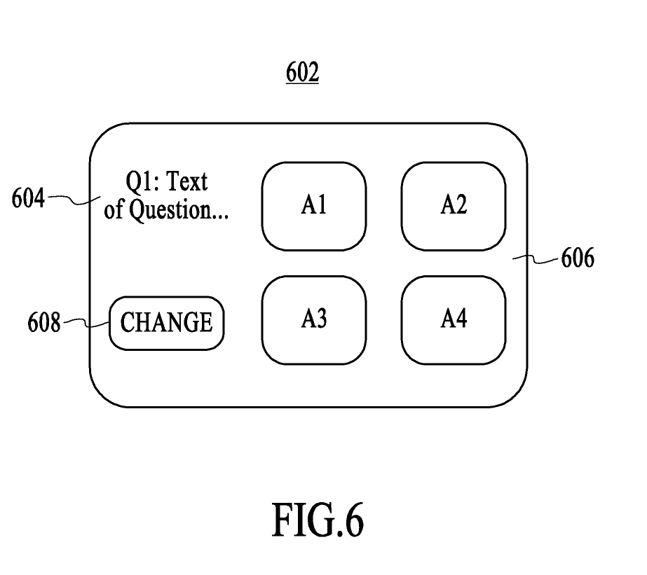

As a widget, the UGP application can be placed and utilized on many different devices. These devices include: cellular or mobile telephony, televisions with interactive features, classroom computers, personal gaming devices, personal digital assistants, and similar devices. The design and layout can be adapted to the needs and constraints of specific users, publishers, advertisers and/or devices. For example, if the user device is a cell phone, the size of the question/response display can be sized accordingly, and the input can be received by touchscreen or keypad input, depending upon the device. FIG. 6 is a sample layout for the questions 604 and graphical responses 606 used in the application on a mobile device, under an embodiment. In this case, the display area 602 is sized for display on a relatively small cell phone display screen. The “change” button 608 on display screen 602 indicates that a new question should be asked. As a top level page, the question/response page may be implemented as part of a terms and conditions (T&C) page that is displayed upon the user entering a website or accessing a particular portal. The selection of an appropriate response may be the same as the user accepting the terms of the T&C page.

The application can be distributed across different mediums as a widget, as a standalone software or as a component of a larger software program. As a widget, it can be distributed across the internet through downloading and embedding but can also be used as a mechanism of constraint whereby the application is the gateway for the user to travel to or access a website or network. The application can be distributed to users across the internet as a downloadable widget which then can be placed and embedded on a website of their choosing. Examples of websites where users may place the application as a widget are blogs, wikis, personal websites, company websites, and social networking sites like Facebook and MySpace.

In a similar manner as the websites, the application can also be distributed to wireless devices. The application can come as a pre-installed application on the device or could simply be downloaded by the device owner from a mobile application store or website online. Examples of a mobile application store where users could download the widget are the Apple® iTunes™ App Store or Youpark.com. Second, the application can be placed as part of an authentication site whereby the user is required to interact with the application in order to use the network's Internet services or to access subsequent pages. As part of the authentication site, the owner of the site would determine the features, design and layout of the application.

The application can also be distributed to users as a standalone piece of software or as a component of a larger piece of software that can be utilized on and offline. In the online environment, the software acts in a similar manner as a widget. In the offline implementation, the application still contains all the same features and technology. Physical stores and locations can use the application as a software and apply the application to users in the offline world. For example, the application can be used as an interactive menu at restaurants or interactive game while waiting at the gas station. Many different implementations exist for embodiments of the UGP application as a standalone software application or component of a larger software program.

As stated above, the UGP application may be implemented as an interactive application that invites user interaction at various stages of the user's web browsing session at a certain web sites or across various web sites. The application may be triggered by certain default conditions, such as navigation through different pages of a site, or from one web site to another. Other trigger conditions may also be defined, such as prior to, or in association with user input to the website. In an embodiment, a first instance of the UGP application is provided as a pre-requisite to user login to a particular web site. This ensures that user interaction to the UGP is initiated at least at some level. Because the question and answer session is relatively simple, eliciting user input is generally not too onerous, as a single click on a picture is all that is needed to proceed. The question and answer object 602 can be displayed in associated (prior or immediately after) the display of a login or registration prompt to a web page, or it can be displayed along with a required input page, such as the T&C page.

To prevent or minimize the possibility of user's simply clicking any button to proceed, rather than taking the brief time to read the simple question and answer thoughtfully, a number of interactive elements can be incorporated. In one embodiment, a historical result page or graphic is provided immediately after the user provides the answer to the question. The result page could provide feedback based on other user's responses, or it can relate the user's responses to previous questions. For example, the response page could include a message such as “you and 50% of the other users selected answer ‘B’” or any similar message or graphical representation of audience breakdown, or statistical representation of user answers.

Embodiments are described with regard to a question and answer panel displayed within a graphical user interface, as shown in FIG. 1. Objects embodying the question and answers may be implemented through any programming structure that is appropriate to the network environment and user devices. For example, the question 102 may be provided as a simple text element, and each of the answers 104 may be graphical objects (shapes, colors, etc.), or pictures in any appropriate format (e.g., JPEG, etc.). Alternatively, the answer elements 104 may be short video clips or audio clips, or any other element that can be perceived by the user and selected as an answer to the question.

### Network Traffic Tagging System

In one embodiment, the UGP application is used in a real-time market segmentation platform (segmentation system) that transforms traditional broadband ISPs into profitable ad-serving channels. The segmentation system allows for secure extraction of audience intelligence that traditionally lay dormant in data warehouses. This audience intelligence is further refined per the requirements of the Internet environment and distributed using standards-friendly protocols. Specifically, a network element product is deployed within ISP networks to insert tags into the traffic stream of HTTP request Headers. The HTTP headers are generated by a web browser when it makes a request for web content, such as a webpage. In one embodiment, the tags are an alphanumeric representation of user profile data that are appended to the HTTP requests made by the user's web browser. In this case, the unique ID generated by the UGP system corresponds to the tags that are generated by a network traffic tagging system. The unique ID represents an encoded version of the MAC address of the device operated by the user. This unique ID is used to reference a database that stores the answer data provided by the user. The demographic data stored within the database may be compiled, formatted, and provided to a content provider who wishes to transmit targeted content to the user. The tag information is used to identify the user for whom the demographic information corresponds. The database stores only the objective, non-personal information consisting of the answer selections, and does not contain any personal information of the user. The tag itself also represents an objective data element related to the address of a network device used by the user.

Through the use of such tags, the system does not handle any Personally Identifiable Information (PII) about a consumer. Furthermore, the system does not perform any user tracking, such as click-stream analysis, behavioral targeting, packet inspection or other similar methods. In general, there is an imbalance in the value of audience intelligence dormant in the service provider networks, to the benefit it brings to the online system. Embodiments of a segmentation system and a related user generated preferences component utilize this information in a meaningful and safe manner. For example, for digital marketing applications, the system provides improved capabilities in the design, optimization, and delivery of advertising and marketing campaigns. The use of tags allows high levels of geographic accuracy with which digital marketers are able to craft messages with a high degree of confidence of reaching the most appropriate audiences.

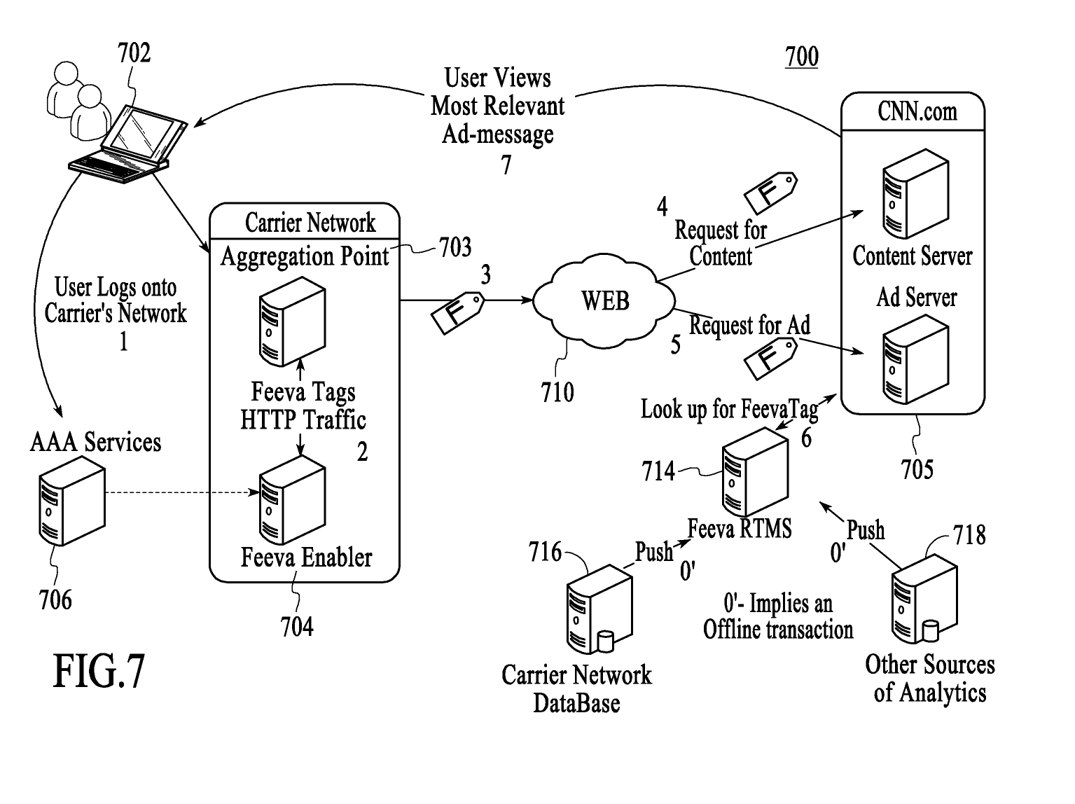

FIG. 7 illustrates a high level architectural view of a network traffic tagging system, under an embodiment. The system of FIG. 7 generates tagged Internet traffic, under an embodiment. As shown in system 700 of FIG. 7, a user 702 logs onto a carrier network 703 (step 1). The carrier network 703 includes an aggregation point and an enabler component 704 The enabler component 704 tags the HTTP traffic with an alphanumeric tag (step 2) and the tagged traffic 3 is then transmitted to the world-wide web portion of the Internet 710. In an embodiment, the user log-in request from step 1 is also transmitted to an AAA server 706 for authentication and transmission to the enabler component 704. The AAA server may implement a client-server protocol, such as the RADIUS protocol, or other similar protocols as well, that enables remote access servers to communicate with a central server to authenticate dial-in users and authorize their access to the requested system or service.

In a typical implementation, the user request will be to a content serving website, such as a commercial website 705 (e.g., CNN.com). This website comprises a content server and an ad server component. The tagged traffic 3 is decomposed into a request for content (step 4) that is transmitted directly to the content server 111, and a request for an ad (step 5) that is transmitted to the ad server within website 705. The tag 3, which encodes certain relevant geographic or demographic information about the user 702, is passed on to an Real-Time Market Segmentation (RTMS) service 714, which decodes the tag to provide relevant information to the ad server so that the most appropriate ad can be served back to the user (step 7). The RTMS process 714 receives information from the carrier network database 716 and other sources 718 in an offline transaction or transactions in order to provide relevant information back to the content server site 705. Similar to RTMS, other Internet-based decrypting authorities may also participate in the process of interpreting the tags, and implement application services.

The tag mechanism of FIG. 7 generally provides a sufficient balance between the need for knowledge, protection of user information, and control over tag data. The system 702 utilizes tags in order to generate tagged traffic directly at a specific network level. This is significantly different from present cookie technology, which operates at the user computer level. Although the concept of cookies initially generated some concerns among consumers, the web-surfing public has gradually become used to the concept of cookies and the general utility that they provide. There are two general types of cookies, persistent and session. Persistent cookies stay on the computer and record information every time a consumer visits some websites. They are stored on the hard drive of the computer until manually deleted from a browser folder, or until they expire, which can be months or years after they were placed on the computer. Session cookies may help with navigation on the website and typically only record information during one visit to a website and then are erased. In the case of session cookies, a user can simply close the web browser or turn off the computer's power, and the session cookies will be deleted automatically. Most cookies can be managed by using cookie deletion software or adjusting the web browser settings. Much more troubling to consumers and to the privacy advocacy organization, however, is the use of flash cookies, which are very difficult to delete for the average consumers and which are not affected by cookie deletion software.

Methods may be included to inform the consumer of the existence of the tagging system within their ISP. This may be done in one of several ways, such as through opt-in/opt-out mechanisms, and the like. A next step is to provide the consumer with a sufficient set of tools and alternatives to create, read, update, and delete profile data associated with themselves. A fundamental part of the system framework is grounded in the concept of meaningful consumer choice. This dictates that consumers should be able to exercise choice with respect to whether and how their anonymous demographic information is used. This is true even in systems that may not use any consumer PII. Thus, regardless of PII use, it is important that users be given a real choice as to whether or not they want to participate. Failure to do so, and to do so in a meaningful manner, risks undermining the trust relationship between customers and their ISPs that is necessary for both the segmentation system administrator and the ISPs to sustain their business models.

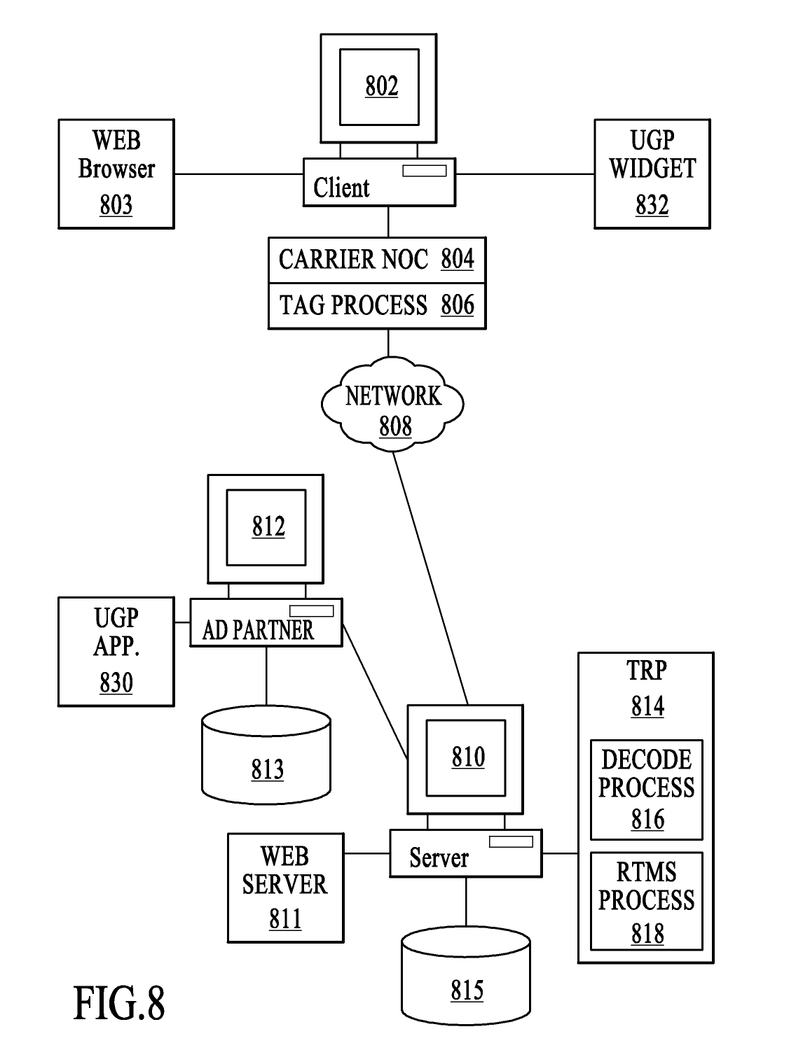

In one embodiment, a network traffic tagging component utilizes information that is collected in a telecommunications-based access network, such as WiFi, WiMAX, mobile, DSL (digital subscriber line), cable, IPTV (Internet Protocol Television), etc., to be used by destination sites, such as web server sites, publishers, content providers, peer-to-peer sites, user generated content sites, advertising networks, search engines, and so on. The network tagging component obtains relevant user and user device information, such as accurate location data and demographic information, and formats the information into a small footprint and universally accessible format. FIG. 8 illustrates a client-server network including a network tagging component, according to an embodiment. As shown in FIG. 8, a client computing device 802 accesses network 808 through a telecommunications pathway provided by carrier network operation center (NOC) 804. One or more routers may also be inserted in the transmission line between client 802 and network 808. The environment shown in FIG. 8 illustrates a standard IP-based access system in which client 802 executing a web browser process 803 accesses a web site destination 810 served by server computer 810 executing a web server process 811. The web server 810 provides content in the form of web pages which may be sourced from a local database 815 or remotely from other servers or data stores. One or more supplemental messages, such as advertisements, may be served by an ad server 812, or similar supplemental content provider that has its own data store 813. The ad server generates ads or supplemental messages that are embedded in, or displayed in conjunction with the content served by the web server 810.

As shown in FIG. 8, a tag processor component 806 is associated with carrier NOC 804. The tag processor component may be a software or hardware component that is included within the functionality provided by carrier NOC 804, or it may be a component that is tightly or loosely coupled to carrier NOC 804. The tag processor component 806 obtains certain identification information associated with the client 806 and encodes the identification information into a portion of the network traffic transmitted by client 802 to server 810. This information is then used by ad partner 812 to determine which ads or messages from among a selection of ads (such as may be stored in database 813) to transmit to server 810 for incorporation into content that is served back to client 802. A separate tag related process (TRP) 814 decodes the encoded identification information and provides the corresponding geographic and location information to the server 810. The TRP 814 can also compile relevant traffic data related to the client 802, or even multiple client computers. This traffic data can then be used by ad partner 212 to dictate appropriate ad serving campaigns.

As shown in FIG. 8, the UGP application may be implemented as either an application program 830 executed on a server or client computer, such as ad partner server 812 or server 810. It may also be implemented as a widget, or similar lightweight application running on client 802. The preference data provided by the question or questions provided to the user are compiled to build a preference profile of the user. This preference data is then correlated to the ID information provided by the tag data to provide comprehensive anonymous demographic user information regarding a user or community of users to the content provider (e.g., the ad network or content server). The profile information from the question/response application can be provided as an iterative mechanism through a series of questions scattered throughout a browsing experience, or all at once through questions displayed concurrently during a single browsing episode. The profile data may be stored in a data base such as datastore 815.

For an embodiment of FIG. 8 in which network 808 is the Internet, network servers may execute web server processes to provide HTML documents, typically in the form of web pages, to client computers coupled to the network. To access the HTML files provided by the servers, the client computers execute web browser processes that accesses web pages available on the Internet server sites. A client computer may access the Internet through an Internet Service Provider (ISP). Data for any web session may be provided by a data store that is closely or loosely coupled to any of the servers and/or clients. The client computer may be a workstation computer or it may be a computing device such as a notebook computer, personal digital assistant, or the like. The client computer may also be embodied within a mobile communication device, game console, media playback unit, or similar computing device that provides access to the Internet and a sufficient degree of user input and processing capability to execute or access the relevant programs. The client computers 1 may be coupled to the server computers over a wired connection, a wireless connection or any combination thereof.

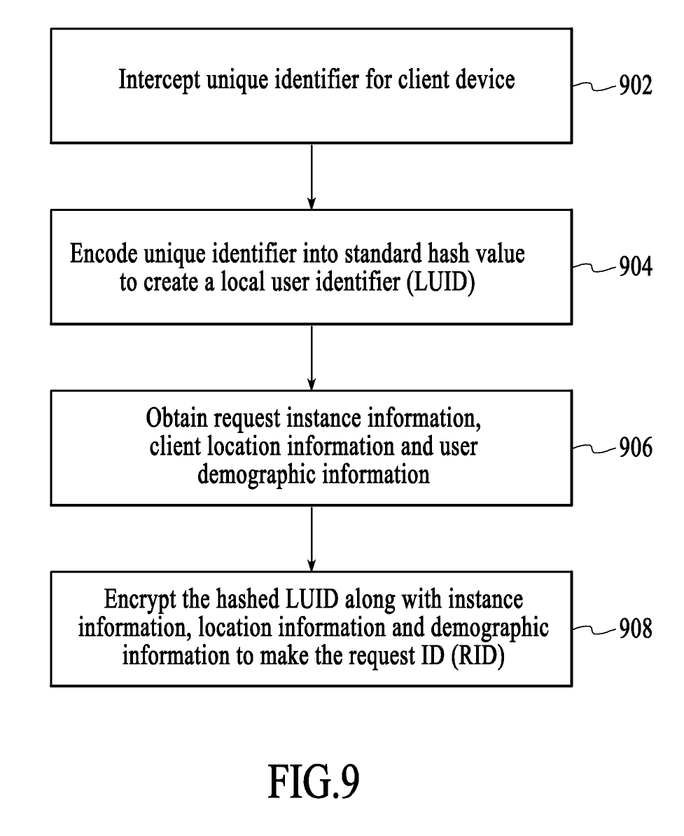

In one embodiment, the tag processor component 806 generates a unique request ID (RID) based on certain information associated with the client 802 and the user. FIG. 9 is a flowchart that illustrates a method of generating a request ID, under an embodiment. The tag processor 806 first intercepts the unique identifier (UID) for the client device, block 902. The unique identifier can be the MAC address, port identifier, or any other hardcoded unique identifier assigned to the client 802. In the case of a mobile device, such as a cellular phone, the unique identifier can be the SIM (subscriber identity module) number, or similar identifier. The UID is then encoded using a standard one-way hash algorithm to create a Local User ID (LUID). Alternatively, any equivalent coding method that ensures adequate privacy may be used to encode the UID as an LUID. In block 906, the tag processor 806 obtains instance information relating to the request, as well as location information relating to the client device and demographic information relating to the user. The instance information can comprise time of the request and can be obtained from clock or timing circuitry within the client computer, or any routing devices that transmit the request. The location information can comprise zip code, phone area code, latitude/longitude, street address, or other available location information for the client device, and may be obtained from location circuitry, such as GPS (global positioning system) circuitry within the client or any associated router or access point, or it may be provided by a database that has such location information. The demographic information can be any relevant profile information related to the user, such as gender, age, race, occupation, income level, product or service preferences, and so on, and may be provided by profile data held by the client device or third party services or related databases. As shown in block 908, the LUID is then encrypted along with the instance information, location information, and demographic information to generate a Request ID (RID).

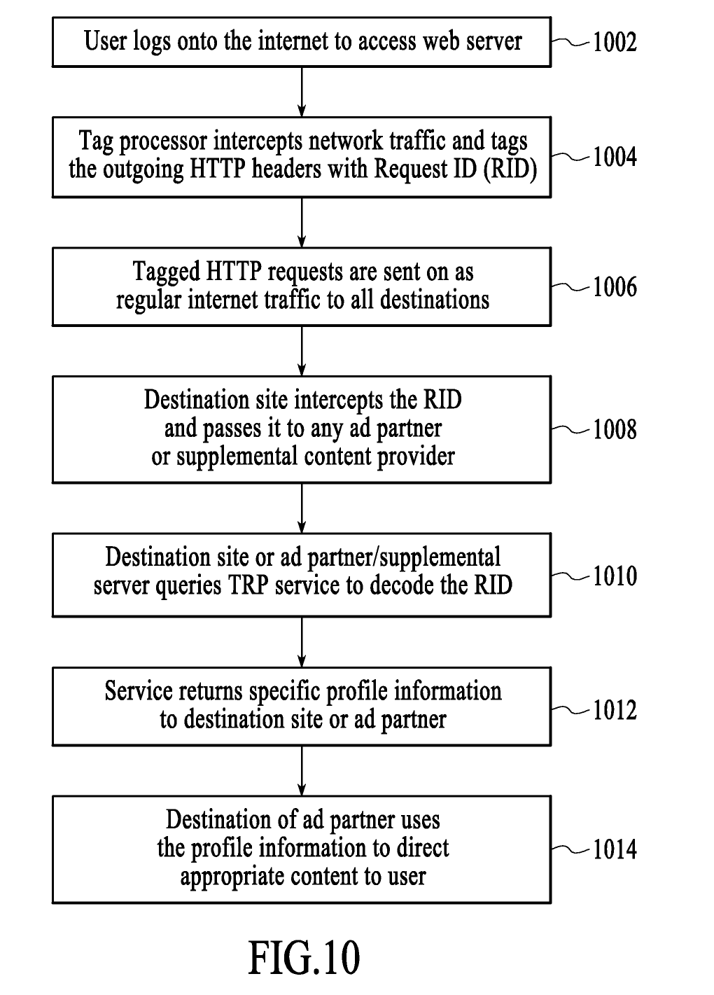

Once the RID has been generated by the tag processor, it is associated with (tagged to) the network traffic between the client and server computers. FIG. 10 is a flowchart that illustrates a method of tagging network traffic with relevant user and/or network client information, under an embodiment. In block 1002, the user, through client 802, logs onto the network and attempts to connect to server 810 over the web network (Internet) 808. During this process, the HTTP requests being made will pass through the carrier NOC 804. Standard HTTP requests include various content fields, such as headers and data fields. They also accommodate incremental information from the network and adjunct databases, as these requests are distributed without filtering across the Internet. In one embodiment, the RID is encrypted in the extensible space of the HTTP header in an appropriate format. In an alternative embodiment, the TCP header can be used to encode the RID. In a further alternative embodiment, both the HTTP and TCP header can be used to encode all or respective portions of the RID.

As shown in block 1004, at the carrier NOC, the tag processor processes the client network traffic comprising the HTTP requests, and tags the outgoing HTTP headers with the request ID's formed in block 908 of FIG. 9. The tagged HTTP requests are then sent on as regular Internet traffic to all destinations on the Internet, as opposed to only destinations on a single network, block 1006.

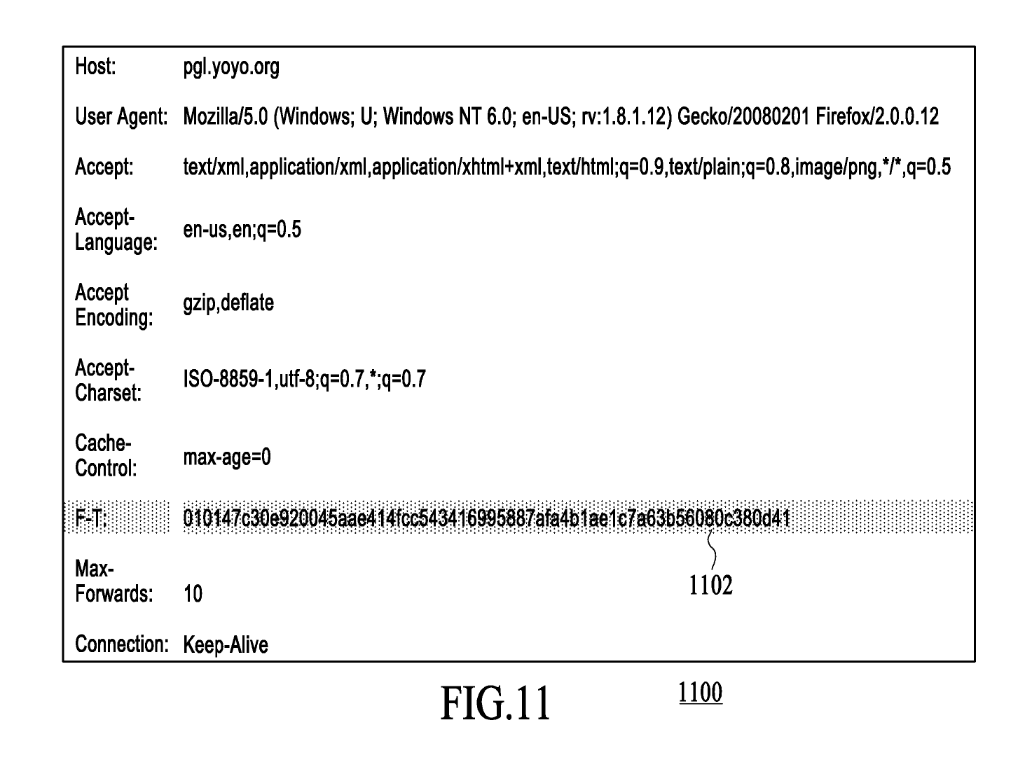

FIG. 11 illustrates an example HTTP header including a network traffic tag, according to an embodiment. The header shown in FIG. 11 has some example values entered for each of the requisite fields. A standard HTTP header includes various fields such as the Host field specifying the URL of the destination site, the User-Agent field specifying the web browser program on the client, an Accept field specifying the format accepted by the browser, an Accept Language field, an Accept Encoding field, and Accept Character Set field, a Cache Control field, a Max-Forwards field and a Connection field. The HTTP header also includes one or more extensible fields that are essentially blank, but can be used to store additional data. For the embodiment illustrated in FIG. 11, the RID is encoded in HTTP header 1100 as a tag (or watermark) in a field denoted “F-T” 1102. The RID tag is encoded as a hexadecimal number of a defined length. The length and position of the RID tag within the HTTP header can be modified depending upon system constraints and requirements.

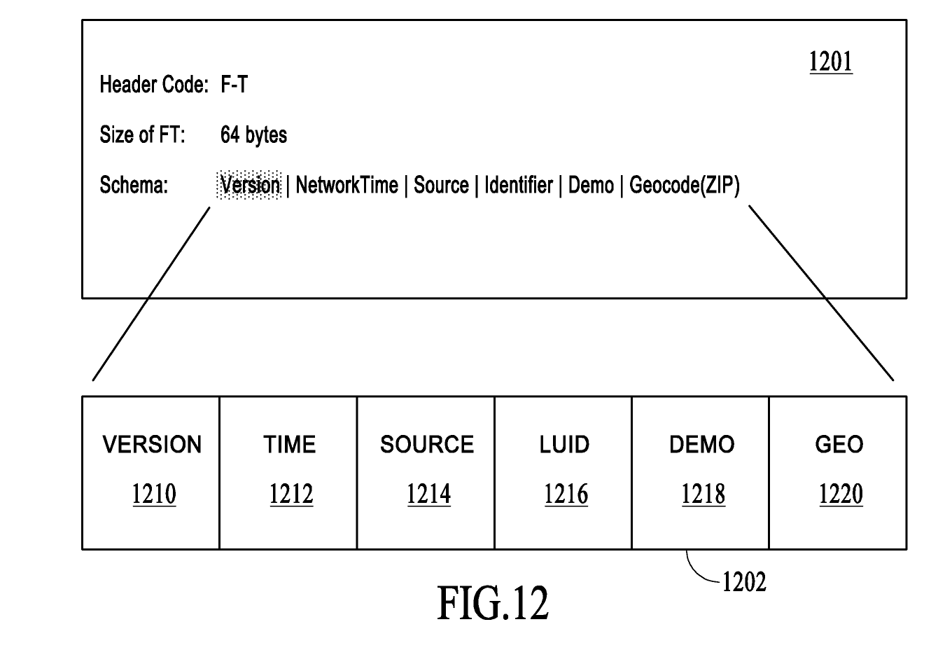

FIG. 12 illustrates the composition of the RID tag, under an embodiment. As shown in FIG. 12, the RID tag 1200 is specified by a header code (e.g., F-T), and has a specified size, for example 64 bytes. The schema 1202 illustrates the actual coding of the data elements within the RID. The version field 1210 contains a control code that uniquely identifies the RID and is different for every HTTP request. The Time field 1212 encodes the time that the request was transmitted from the client. The Source field 1214 contains the unique ID associated with the client. The LUID field 1216 contains the local user ID generated through the hash process executed by the tag processor component in block 904 of FIG. 9. The Demographic field 1218 encodes the demographic data for the user. The Geographic field 1220 encodes the location data of the client device. As shown in field 1102 of FIG. 11, an example RID tag in the F-T field comprises the values for each of these fields into a single hexadecimal number of length 64-bytes. Each individual field can be encoded according to a specific scheme. For example, the geographic data could comprise zip or zip+4 data, latitude/longitude, or street address data that is encoded into a corresponding hexadecimal number. Likewise, the demographic data comprises a hexadecimal number that corresponds to the profile information relating to various characteristics (e.g., gender, race, age, etc.) of the user. Actual coding schemes can be defined by the user. Similarly, each of the other fields encodes their respective data into hexadecimal values. Alternatively, any other appropriate numerical base, other than hexadecimal, could be used to encode the RID tag.

With reference back to FIG. 10, in block 1008, the destination site intercepts the RID from the HTTP header and passes it on to any associated ad partner or supplemental content provider. Many popular web destinations use advertising partners to provide and place ads. They may also have content partners or search engines or other media/content services. These supplemental servers are normally used to send a request for particular information related both to the destination website as the request from the user. The RID is used to enhance the relevance of the ads or supplemental messages provided by these supplemental servers. It can be used to select appropriate ads from a set of ads, or tailor ads for specific users by insertion of customized information. In the case of a TCP option request, sockets are used to extract the RID information and require either a software stack or network appliance.

In general, the destination site (server computer 810 or ad partner 812) receive and collect the tagged RIDs as they are extracted from the HTTP requests sent by the client computer. In one embodiment, they may be provided with decoding capability so that they can extract the corresponding location and demographic information directly themselves. In a preferred embodiment, however, this decoding process is provided by a separate process provided by TRP 814. Thus, for the embodiment shown in FIG. 10, in block 1010, the destination site, or the ad server/supplemental server queries TRP 814 to decipher the true value embedded in the request ID. This is typically accomplished by decoding the RID value encoded in the HTTP (or TCP) header. The TRP then returns specific profile information to the destination site or ad partner, block 1012. This information comprises the geographic (location) demographic, technographic, psychographic, or other values pertaining to the RID. The destination or ad partner then uses the profile information to direct appropriate content to the user, block 1014. This appropriate content is referred to as “directed media” and can comprise a media tag identifying a media or type of media, and can consist of or reference advertisement messages, coupons, video content, audio content, or any other media which is tailored to the user identity, location, and/or preferences.

In one embodiment, the user information (e.g., geographic, demographic, psychographic information) for the tag is obtained at run-time. In the context of an ad-serving application or any other third party content or supplemental message serving system, run-time refers to the moment when the ad or supplemental message is served to the user and displayed on the user device. For this embodiment, the tag is decrypted by the content provider in real-time coincident with the web-based request by the user. This allows the content provider to serve the appropriate message or ad based on the generic anonymous data of the user, thus enabling the delivery of targeted content to specific users or classes of users. The combination of real-time serving and decryption of tag information relating to the user efficiently enables the creation of dynamic ad campaigns and effective targeted ad serving to large populations of users. According to embodiments described herein, network statistics regarding a plurality of users can be obtained at runtime by the content provider and used for the aggregation of metrics regarding the users. This facilitates the creation of comprehensive ad campaigns and targeted content serving based user preferences, geographic data, and other related data that are tied to and obtained from persistent profiles associated with each individual user.

In one embodiment, the ad campaign management feature provided by the TRP allows for the implementation of certain advanced features, such as ad sequencing. In this embodiment, certain scheduling parameters can be set based on a static set of profile data or on periodically obtained profile data. A forecast module may provide a forecast of actual profile data based on historic profile data for a user or client computer, or predictions based on certain relevant trends. This information can be used by the content provider to automatically serve content based on previously obtained profile data. It also allows for the serving of messages based on content and/or defined business rules.

Embodiments of a method for implementing a user generated preference application for discovering user preferences in a targeted content delivery system are disclosed. Specifically, what is disclosed is a User Generated Preferences (UGP) application for discovering, accumulating and protecting online user preferences, comprising a graphical user interface of a question with answers represented by pictures. Embodiments of the graphic user interface, comprise a design that is simple, entertaining, and interactive, a layout and design that is adaptable to a particular user, publisher or advertisers needs, a layout and design that is adaptable to different devices, a process that identifies, gathers, and stores preferences chosen by individual online users, and a complex decision mechanism that serves and rotates questions with graphical answers to users based on previously selected answers.

In one embodiment, the decision mechanism can be turned off and serve the questions with picture answers at random, a decision mechanism that is adaptable whereby questions with picture answers can be added into the decision rotation based on the category selected to place the question, an encryption mechanism to safeguard, protect and ensure user privacy, a feedback mechanism to reveal the percentage of people who selected certain answers, and a ‘change answers’ button that will re-display different graphical responses pertaining to the same question. The decision mechanism will be able to take secondary actions based on user inputs, such that the web process can redirect to another website, transform and/or recreate current website, and dynamically form subsequent pages based on the user's previous inputs.

The UGP application may be distributed as a free standing widget that can be packaged and placed on web sites by other users, publishers and advertisers. Embodiments of the free standing widget include the ability to be sponsored by third parties, the ability to have specific questions sponsored by third parties, the ability to be “white labeled”, meaning sold and re-branded by purchasing third parties, the ability to be licensed to third parties, the ability to be distributed across websites by downloading, and the ability to be embedded in additional websites, such as blogs, wikis, personal websites, corporate websites and social networking sites.

The UGP application may also be distributed as a stand-alone software program or component of a larger software program that can be distributed online and offline. Embodiments of the stand-alone software program include, the ability to be packaged and distributed online and offline at physical locations, the ability to be used by users, publishers, advertisers, physical store owners, educational institutions and persons offline, and the ability to be “white labeled” as a software component of a larger software program, meaning sold and re-branded by purchasing third parties.

Embodiments are directed to a method of discovering user preferences in a targeted content delivery system, comprising: displaying, in a graphical user interface (GUI), a question and answer panel comprising a simple question and a plurality of graphical elements each representing a separate answer to the question, wherein the question and answers do not invoke any private personal information of the user; receiving an answer from the user in the form of a user selection of a graphical element selected by the user through the GUI; creating an anonymous device identifier (ID) that associates the answer to the user; storing the answer referenced by the device identifier in a data store; and setting a protocol in a network routing device to tag network traffic bound for a remote Internet-based content service based on the user's answer. The method further comprises encrypting the device identifier and applying a one-way hash algorithm prior to storage of the answer data in the data store. In this method, the question is intended to elicit an objective fact about the user. In this method, each answer comprises a simple picture, and a user's selection of an answer indicates at least one of: a gender of the user, an age range of the user, a residence location, ethnicity of the user, language spoken by the user, and a purchase preference of the user.

The method of this embodiment may further comprise: displaying first question and answer panel upon a first interaction of the user with a web site; displaying at least one additional question and answer panel upon a subsequent interaction of the user with the website; and storing the answer or answers to the at least one additional question in the data store to construct an objective user profile of the user. In this method, the first interaction may comprise a user login procedure to initiate a web browsing session in the web site, and the second interaction may comprise one of navigating from a first page to a second page within the website, or navigating from the web site to an alternate web site. The method may further comprise displaying a feedback page after the first question and answer panel indicating other user's answers to the question of the first question and answer panel. In this method, the at least one additional question is formulated to elicit an additional fact about the user and is selected through a decision tree analysis process. In this method, the at least one additional question is formulated to confirm the answer provided by the user to the first question.

The method of the embodiment further comprises providing the user profile information to a content provider to facilitate optimization of delivery of targeted content to the user based on the user's profile information.

The method may further comprise encoding the anonymous device identifier in a tag that is included as part of the extensible space of an HTTP header portion of the outgoing traffic bound for the remote Internet-based content service. The method may yet further comprise decoding the tag in a tag-related process that provides the corresponding objective factual information regarding the user to a server for use by a targeted content provider for use in delivering targeted content to the user.

Embodiments are further directed to a message of compiling user preferences for use by targeted content providers, comprising: displaying, in a graphical user interface (GUI), a first question and answer panel comprising a simple question and a plurality of graphical elements each representing a separate answer to the question, wherein the question and answers do not invoke any private personal information of the user; receiving a first answer from the user in the form of a user selection of a graphical element selected by the user through the GUI; creating a first anonymous device identifier (ID) that associates the first answer to the user; displaying a second question and answer panel to the user in response to the first answer; storing the first and second answers in a data store referenced by the anonymous device ID; using the first and second answer to construct a user profile of the user; and providing the user profile information to a content provider to facilitate optimization of delivery of targeted content to the user based on the user's profile information. In this method, the first question and second question are intended to elicit an objective fact about the user; and each answer to the first and second questions comprises a simple picture, and a user's selection of an answer indicates at least one of: a gender of the user, an age range of the user, a residence location, ethnicity of the user, language spoken by the user, and a purchase preference of the user. In this method, the first question and answer panel is displayed upon an initial interaction of the user with the web site, and wherein the second question and answer panel is displayed upon a subsequent interaction of the user with the website.

In an embodiment of the method, the first interaction comprises a user login procedure to initiate a web browsing session in the web site, and wherein the second interaction comprises one of navigating from a first page to a second page within the website, or navigating from the web site to an alternate web site. The second question may be formulated to elicit an additional fact about the user and is selected through a decision tree analysis process. Alternatively, the method may be formulated to confirm the answer provided by the user to the first question. In an embodiment of the method, the anonymous device ID comprises a MAC address of a device operated by the user, and the method further comprises: setting a protocol in a network routing device to tag network traffic bound for a remote Internet-based content service based on the user profile information.

The method may further comprise: storing the answers to the first and second questions as digits corresponding to the question number and answer selection; decoding the digits into demographic data; and compiling the demographic data into a standardized format for use by a targeted content provider.

The method may yet further comprise encoding the user profile information embodying the anonymous device identifiers in a tag that is included as part of the extensible space of an HTTP header portion of the outgoing traffic bound for the remote Internet-based content service. The method may further yet comprise decoding the tag in a tag-related process that provides the corresponding objective factual information regarding the user to a server for use by a targeted content provider for use in delivering targeted content to the user.

Aspects of the process described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: microcontrollers with memory (such as EEPROM), embedded microprocessors, firmware, software, etc. Furthermore, aspects of the method may be embodied in microprocessors having software-based circuit emulation, discrete logic (sequential and combinatorial), custom devices, fuzzy (neural) logic, quantum devices, and hybrids of any of the above device types.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the process is not intended to be exhaustive or to limit the embodiments to the precise form or instructions disclosed. While specific embodiments of, and examples for, processes in computing devices are described herein for illustrative purposes, various equivalent modifications are possible within the scope of the disclosed methods and structures, as those skilled in the relevant art will recognize. The elements and acts of the various embodiments described above can be combined to provide further embodiments. These and other changes can be made in light of the above detailed description.

What is claimed is:

1. A method of discovering user preferences in a targeted content delivery system, comprising:
displaying, in a graphical user interface (GUI), a question and answer panel comprising a simple question and a plurality of graphical elements each representing a separate answer to the question, wherein the question and answers do not invoke any private personal information of the user;
receiving an answer from the user in the form of a user selection of a graphical element selected by the user through the GUI;
creating an anonymous device identifier (ID) that associates the answer to the user;
storing the answer data referenced by the device identifier in a data store; and
setting a protocol in a network routing device to tag network traffic bound for a remote Internet-based content service based on the user's answer.

2. The method of claim 1 further comprising encrypting the device identifier and applying a one-way hash algorithm prior to storage of the answer data in the data store.

3. The method of claim 1 wherein the question is intended to elicit an objective fact about the user.

4. The method of claim 3 wherein each answer comprises a simple picture, and a user's selection of an answer indicates at least one of: a gender of the user, an age range of the user, a residence location, ethnicity of the user, language spoken by the user, and a purchase preference of the user.

5. The method of claim 1 further comprising:
displaying first question and answer panel upon a first interaction of the user with a web site;
displaying at least one additional question and answer panel upon a subsequent interaction of the user with the website; and
storing the answer or answers to the at least one additional question in the data store to construct an objective user profile of the user.

6. The method of claim 5 wherein the first interaction comprises a user login procedure to initiate a web browsing session in the web site, and wherein the second interaction comprises one of navigating from a first page to a second page within the website, or navigating from the web site to an alternate web site.

7. The method of claim 6 further comprising: displaying a feedback page after the first question and answer panel indicating other user's answers to the question of the first question and answer panel.

8. The method of claim 5 wherein the at least one additional question is formulated to elicit an additional fact about the user and is selected through a decision tree analysis process.

9. The method of claim 5 wherein the at least one additional question is formulated to confirm the answer provided by the user to the first question.

10. The method of claim 8 further comprising providing the user profile information to a content provider to facilitate optimization of delivery of targeted content to the user based on the user's profile information.

11. The method of claim 1 further comprising encoding the anonymous device identifier in a tag that is included as part of the extensible space of a hypertext transport protocol (HTTP) header portion of the outgoing traffic bound for the remote Internet-based content service.

12. The method of claim 11 further comprising decoding the tag in a tag-related process that provides the corresponding objective factual information regarding the user to a server for use by a targeted content provider for use in delivering targeted content to the user.

13. A method of compiling user preferences for use by targeted content providers, comprising:
displaying, in a graphical user interface (GUI), a first question and answer panel comprising a simple question and a plurality of graphical elements each representing a separate answer to the question, wherein the question and answers do not invoke any non-objective personal information of the user;
receiving a first answer from the user in the form of a user selection of a graphical element selected by the user through the GUI;
creating a first anonymous device identifier (ID) that associates the first answer to the user;
displaying a second question and answer panel to the user in response to the first answer;
storing the first and second answers in a data store referenced by the anonymous device ID;
using the first and second answer to construct a user profile of the user; and
providing the user profile information to a content provider to facilitate optimization of delivery of targeted content to the user based on the user's profile information.

14. The method of claim 13 wherein the first question and second question are intended to elicit an objective fact about the user.

15. The method of claim 14 wherein each answer to the first and second questions comprises a simple picture, and a user's selection of an answer indicates at least one of: a gender of the user, an age range of the user, a residence location, ethnicity of the user, language spoken by the user, and a purchase preference of the user.

16. The method of claim 15 further wherein the first question and answer panel is displayed upon an initial interaction of the user with the web site, and wherein the second question and answer panel is displayed upon a subsequent interaction of the user with the website.

17. The method of claim 16 wherein the first interaction comprises a user login procedure to initiate a web browsing session in the web site, and wherein the second interaction comprises one of navigating from a first page to a second page within the website, or navigating from the web site to an alternate web site.

18. The method of claim 17 wherein the second question is formulated to elicit an additional fact about the user and is selected through a decision tree analysis process.

19. The method of claim 17 wherein the second question is formulated to confirm the answer provided by the user to the first question.

20. The method of claim 13 wherein the anonymous device (ID) comprises a network address of a Media Access Controller (MAC) device operated by the user, the method further comprising: setting a protocol in a network routing device to tag network traffic bound for a remote Internet-based content service based on the user profile information.

21. The method of claim 20 further comprising encoding the user profile information embodying the anonymous device identifiers in a tag that is included as part of the extensible space of a hypertext transport protocol (HTTP) header portion of the outgoing traffic bound for the remote Internet-based content service.

22. The method of claim 21 further comprising:
storing the answers to the first and second questions as digits corresponding to the question number and answer selection;
decoding the digits into demographic data; and
compiling the demographic data into a standardized format for use by a targeted content provider.

23. The method of claim 21 further comprising decoding the tag in a tag-related process that references the database entry containing the objective factual information regarding the user to a server for use by a targeted content provider for use in delivering targeted content to the user.
